(19) United States
(12) Patent Application Publication
(10) Pub. No.: US 2026/0223226 A1
(43) Pub. Date: Jul. 30, 2026

(54) DATA UNIT INFORMATION TRANSMISSION METHOD

(71) Applicant: ZTE CORPORATION, Shenzhen (CN)

(72) Inventor: Liquan YUAN, Shenzhen (CN)

(21) Appl. No.: 19/536,408

(22) Filed: Feb. 11, 2026

Related U.S. Application Data
(63) Continuation of application No. PCT/CN2024/087056, filed on Apr. 10, 2024.

(30) Foreign Application Priority Data
Aug. 11, 2023 (CN) 202311021183.0

(51) Int. Cl. H04W 76/15; H04W 52/02

(52) U.S. Cl. CPC H04W 76/15; H04W 52/0235

(57) ABSTRACT

Provide is a method for transmitting data unit information. The method includes: determining a first multi-link network device and a second multi-link network device which communicate with each other via a backhaul network, wherein a multi-link connection is established among a target multi-link device, the first multi-link network device and the second multi-link network device, and the first multi-link network device is configured to perform information synchronization with the second multi-link network device via the backhaul network; transmitting, through the first multi-link network device, data unit information, and/or transmitting, through the second multi-link network device, the data unit information, within a configured transmission time corresponding to the configuration information; and selecting the first multi-link network device or the second multi-link network device to transmit the data unit information, within the temporary transmission time.

### DESCRIPTION

This is a Continuation of International Application Number PCT/CN2024/087056, filed on Apr. 10, 2024, which claims priority to Chinese Patent Application No. 202311021183.0, filed to the China National Intellectual Property Administration on Aug. 11, 2023, and entitled “Data Unit Information Transmission Method”, both of which said applications are incorporated herein by reference in their entirety.

### TECHNICAL FIELD

The present disclosure relates to the field of communications, and in particular to a method for transmitting data unit information.

### BACKGROUND

As shown in FIG. 1, a UHR AP MLD (ultra high reliability access point multi-link device) includes a UHR upper MAC (ultra high reliability upper medium access control) and a plurality of EHT AP MLDs (extremely high throughput access point multi-link devices) defined by 802.11be. The plurality of EHT AP MLDs establish a connection with the UHR upper MAC via a wired or wireless manner, and a network connection between the EHT AP MLDs is referred to as a “backhaul network”.

Therefore, an affiliated AP under an EHT AP MLD may communicate with an affiliated AP under another EHT AP MLD via the backhaul network (which may also be expressed as an EHT AP MLD communicates with another EHT AP MLD via the backhaul network).

When a non-AP MLD establishes multiple links with a UHR AP MLD by means of a plurality of EHT AP MLDs, the following problems rises:
when the non-AP MLD operates in an NSTR (nonsimultaneous transmit and receive) mode, since it is very difficult to implement the end time alignment function of PPDUs (PHY protocol data units) of AP1 and AP2, the UHR AP MLD cannot communicate with the non-AP MLD simultaneously via two links, AP1/STA1 (Station terminal) and AP2/STA2 (Station terminal), but can communicate with the non-AP MLD via a single link. Since there is no synchronization signal between AP1 and AP2, one link (AP1) cannot know whether another link (AP2) is transmitting data or not, and the start time of data transmission.

When STA1 and STA2 of the non-AP MLD are a pair of EMLSR (Enhanced multi-link single radio)/EMLMR (Enhanced multi-link multi-radio) links, only one AP can communicate with the UHR AP MLD within a period of time. Since there is no synchronization signal between AP1 and AP2, one link (AP1) cannot know whether the other link (AP2) is transmitting data or not, and the start time of data transmission.

When STA1 and STA2 of the non-AP MLD are a pair of EMLSR/EMLMR links or a pair of NSTR links, only one AP can communicate with the UHR AP MLD within a period of time, but the time for each AP to transmit beacon frames and multicast frames is independent of each other. When AP1 transmits data with STA1, since there is no synchronization signal between AP1 and AP2, STA2 may miss beacon frames or other multicast data transmitted on AP2.

When STA1 and STA2 of the non-AP MLD are a pair of EMLSR/EMLMR links or a pair of NSTR links, only one AP can communicate with the UHR AP MLD within a period of time, but the time period for each AP to establish a TWT (Target Wake Time) is independent of each other, and similarly, joining STA1 and STA2 to corresponding TWT groups is also independent of each other. For example, STA2 joins a TWT group established by AP2, and when AP1 transmits data with STA1, since there is no synchronization signal between AP2 and AP1, STA2 may miss the service time of the TWT group on AP2, and vice versa.

Aiming at the technical problem of how to transmit data unit information on a plurality of links between a UHR AP MLD and a non-AP MLD in the related art, no effective solution has been proposed at present.

Therefore, it is necessary to improve the related art to overcome the defect in the related art.

### SUMMARY

Embodiments of the present disclosure provide a method for transmitting data unit information, so as to at least solve the technical problem of how to transmit data unit information on a plurality of links between a UHR AP MLD and a non-AP MLD.

According to one aspect of the embodiments of the present disclosure, a method for transmitting data unit information is provided, and the method includes: determining a first multi-link network device and a second multi-link network device which communicate with each other via a backhaul network, wherein a multi-link connection is established among a target multi-link device, the first multi-link network device and the second multi-link network device, and the first multi-link network device is configured to perform information synchronization with the second multi-link network device via the backhaul network, wherein the backhaul network represents a network in which different multi-link network devices are connected in a wired or wireless manner, and the synchronized information includes configuration information and temporary transmission time; transmitting, by the first multi-link network device, data unit information, and/or transmitting, by the second multi-link network device, the data unit information, within a configured transmission time corresponding to the configuration information; and selecting the first multi-link network device or the second multi-link network device to transmit the data unit information, within the temporary transmission time.

According to another aspect of the embodiments of the present disclosure, an apparatus for transmitting data unit information is further provided, and the apparatus includes: a synchronization module, configured to determine a first multi-link network device and a second multi-link network device which communicate with each other via a backhaul network, wherein multi-link connection is established among a target multi-link device, the first multi-link network device and the second multi-link network device, and the first multi-link network device is configured to perform information synchronization with the second multi-link network device via the backhaul network, the backhaul network represents a network in which different multi-link network devices are connected in a wired or wireless manner, and the synchronized information includes configuration information and temporary transmission time; a first transmission module, configured to transmit, through the first multi-link network device, data unit information, and/or transmit, through the second multi-link network device, the data unit information, within a configured transmission time corresponding to the configuration information; and a second transmission module, configured to select the first multi-link network device or the second multi-link network device to transmit the data unit information, within the temporary transmission time.

According to another aspect of the embodiments of the present disclosure, a computer-readable storage medium is further provided, the computer-readable storage medium stores a computer program therein, wherein the computer program is configured to, when executed, implement the method for transmitting data unit information.

According to another aspect of the embodiments of the present disclosure, an electronic device is further provided, the electronic device includes a memory, a processor and a computer program stored in the memory and executable by the processor, wherein the processor executes the method for transmitting data unit information by means of the computer program.

By means of the present disclosure, a first multi-link network device and a second multi-link network device which communicate with each other via a backhaul network can be determined, wherein a multi-link connection is established between the first multi-link network device and the second multi-link network device among multi-link devices, such that the first multi-link network device and the second multi-link network device can synchronize information including configuration information and temporary transmission time via the backhaul network, the backhaul network represents a network in which different multi-link network devices are connected in a wired or wireless manner; within a configured transmission time corresponding to the configuration information, data unit information may be transmitted by means of the first multi-link network device, and/or data unit information may be transmitted by means of the second multi-link network device; and within the temporary transmission time, the first multi-link network device or the second multi-link network device may be selected to transmit the data unit information. The present disclosure solves the technical problem of how to transmit data unit information on a plurality of links between a UHR AP MLD and a non-AP MLD.

### BRIEF DESCRIPTION OF THE DRAWINGS

The drawings illustrated herein are used for providing further understanding of the present disclosure and constitute a part of the present disclosure, and the illustrative embodiments of the present disclosure and illustrations thereof are used for explaining the present disclosure, rather than constituting limitation to the present disclosure. In the drawings:

FIG. 1 is a network architecture diagram of a UHR AP MLD according to embodiments of the present disclosure;

FIG. 2 is a schematic diagram of an establishment process of a multi-link connection according to embodiments of the present disclosure;

FIG. 3 is a schematic diagram of a nonsimultaneous transmit and receive mode between an AP MLD and an NSTR non-AP MLD according to embodiments of the present disclosure;

FIG. 4 is a schematic diagram of a single-link transmission mode between an AP MLD and an NSTR non-AP MLD according to embodiments of the present disclosure;

FIG. 5 is a schematic diagram of a link switching method for an enhanced multi-link single radio STA shown in FIGS. 2-4 according to embodiments of the present disclosure;

FIG. 6 is a schematic diagram of dynamic antenna adjustment for an EMLMR non-AP MLD according to embodiments of the present disclosure;

FIG. 7 is an architecture diagram of a UHR AP MLD of an integrated UHR upper MAC according to embodiments of the present disclosure;

FIG. 8 is a topology diagram of communication between an NSTR/EMLSR/EMLMR non-AP MLD and a UHR AP MLD according to embodiments of the present disclosure;

FIG. 9 is a structural block diagram of hardware of a computer terminal for a method for transmitting data unit information according to embodiments of the present disclosure;

FIG. 10 is a flowchart of a method for transmitting data unit information according to embodiments of the present disclosure;

FIG. 11 is a schematic flowchart of negotiating a transmission time period between two links according to embodiments of the present disclosure;

FIG. 12 is a schematic flowchart of a first link on a backhaul network according to embodiments of the present disclosure; and

FIG. 13 is a structural block diagram of an apparatus for transmitting data unit information according to embodiments of the present disclosure.

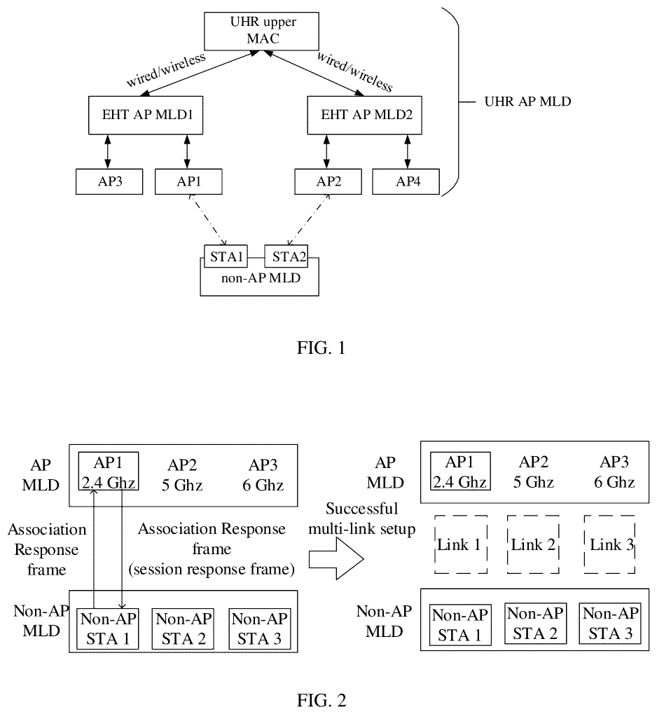

### DETAILED DESCRIPTION OF THE EMBODIMENTS

In order to enable a person skilled in the art to understand the solutions of the present disclosure better, hereinafter, the technical solutions in the embodiments of the present disclosure will be described clearly and completely with reference to the accompanying drawings of embodiments of the present disclosure. Obviously, the embodiments described are only some of embodiments of the present disclosure, rather than all the embodiments. Based on the embodiments in the present disclosure, all other embodiments obtained by a person of ordinary skill in the art without paying creative effort shall all fall within the protection scope of the present disclosure.

It should be noted that the terms “first”, “second”, etc. in the description, claims and drawings of the present disclosure are used to distinguish similar objects, and are not necessarily used to describe a specific sequence or a precedence order. It should be understood that the data so used may be interchanged where appropriate so that embodiments of the present disclosure described herein may be implemented in sequences other than those illustrated or described herein. In should be noted that terms “comprise/include” and “have/has” and any variations thereof are intended to cover a non-exclusive inclusion, for example, a process, method, system, product or device which includes a series of steps or units is not necessarily limited to those steps or units that are clearly listed, but may include other steps or units that are not clearly listed or inherent to these processes, methods, products or devices.

It should be noted that some technical terms in the description, claims and drawings of the present disclosure may be written in customary notations or abbreviations of those skilled in the art. In order to clarify the meanings represented by the customary notations or abbreviations of technical terms, the abbreviations, full English names and explanations of some technical terms are listed herein, specifically as follows:
AP, Access Point, representing an access point;
BSS, Basic Service Set, representing a basic service set;
BSSID, Basic Service Set identifier, representing a basic service set identifier;
DTIM, delivery traffic indication map, representing a delivery traffic indication;
EHT, extremely high throughput, representing an extremely high throughput;
EMLSR, Enhanced multi-link single radio, representing an enhanced multi-link single radio;
EMLMR, Enhanced multi-link multi-radio, representing an enhanced multi-link multi-radio;
ESS, extended service set, representing an extended service set;
GTK, Group Temporal Key, representing a group temporal key;
MAC, medium access control, representing medium access control;
MLD, multi-link device, representing a multi-link device;
MLO, multi-link operation, representing a multi-link operation;
NSTR, Nonsimultaneous transmit and receive, representing nonsimultaneous transmit and receive;
PPDU, PHY protocol data unit, representing a physical layer protocol data unit;
PTK, Pairwise Transient Key, representing a pairwise transient key;
STA, Station, representing a station;
SG, study group, representing a study group;
SSID, service set identifier, representing a service set identifier;
TWT, Target Wake Time, representing a target wake time;
i-TWT, individual TWT, representing an individual target wake time;
b-TWT, broadcast TWT, representing a broadcast target wake time;
r-TWT, restricted TWT, representing a restricted target wake time; and
UHR, Ultra high reliability, representing ultra high reliability.

In order to facilitate understanding and reading of the technical solutions of the embodiments of the present disclosure, some nouns or terms involved in the description of the present disclosure are described below:

802.11be protocol: i.e. the Wi-Fi 7 protocol, which introduces a multi-link operation (MLO) technology, that is, a multi-link device (MLD) includes a network device (AP MLD) and a terminal device (non-AP MLD), which can simultaneously transmit data on a plurality of links, improving the throughput of data transmission and reducing the latency.

The AP MLD and the non-AP MLD perform a 4-way handshake on a link, and then a temporary pairwise transient key (PTK) of an MLO level and a group temporal key (GTK) of a link level are generated, which are used to encrypt and decrypt transmitted unicast data frames and broadcast data frames, respectively, ensuring the security of data transmission.

For example, FIG. 2 is a schematic diagram of an establishment process of a multi-link connection according to embodiments of the present disclosure. As shown in FIG. 2, the AP MLD and the non-AP MLD both include three links operating at 2.4 GHz, 5 GHz and 6 GHz. The AP MLD and the non-AP MLD complete authentication, connection and 4-way handshake processes on the 2.4 GHz link, and once a multi-link connection is established, data can be transmitted on the three links.

802.11be NSTR non-AP MLD: the 802.11be protocol defines nonsimultaneous transmit and receive (NSTR) devices. When a PHY protocol data unit (PPDU) needs to be transmitted on two links, the time for transmitting and receiving the PPDU on the two links, especially the end time of the PPDU, needs to be aligned for simultaneous transmission.

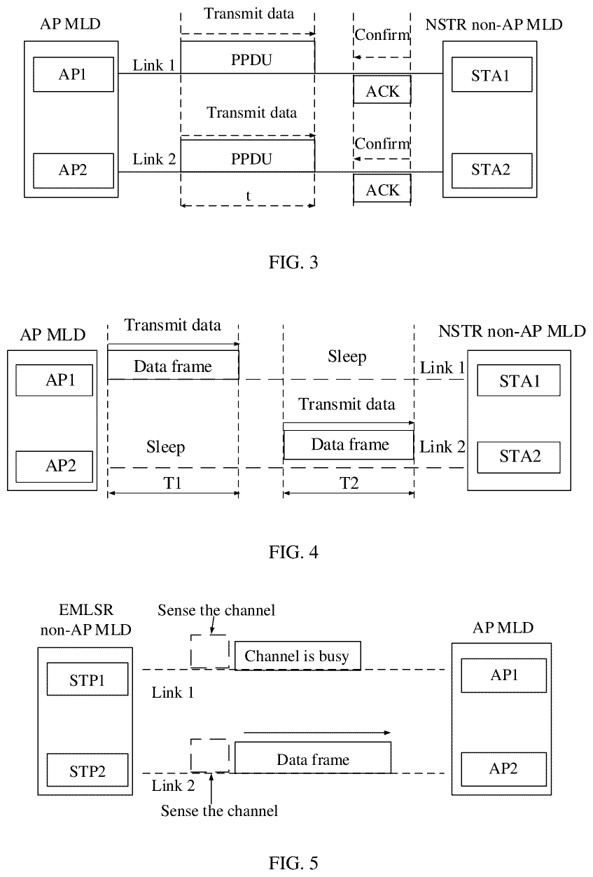

FIG. 3 is a schematic diagram of a nonsimultaneous transmit and receive mode between an AP MLD and an NSTR non-AP MLD according to embodiments of the present disclosure. As shown in FIG. 3, the AP MLD and the NSTR non-AP MLD establish connections on two links, and AP1 and AP2 simultaneously transmit data to STA1 and STA2 on the two links, and simultaneously receive acknowledgment frames replied by STA1 and STA2.

FIG. 4 is a schematic diagram of a single-link transmission mode between an AP MLD and an NSTR non-AP MLD according to embodiments of the present disclosure, specifically as shown in FIG. 4. In some cases, the NSTR non-AP MLD may perform single-link communication with the AP MLD, for example, during a time period T1, a PPDU is transmitted on a link 1, and a link 2 is in a sleep state; and during a time period T2, the PPDU is transmitted on the link 2, and the link 1 is in a sleep state.

802.11be EMLSR: an enhanced multi-link single radio (EMLSR non-AP MLD) device is a multi-link device that supports simultaneous channel sensing on a plurality of links, but can only select one link at a time for data transmission.

With respect to the limitation of a multi-link single radio device needing to sense a channel first before deciding to switch a link, the enhanced multi-link single radio device supports simultaneous channel sensing on a plurality of links, and then selects an idle channel to transmit data, thereby reducing the waiting latency required for channel sensing.

FIG. 5 is a schematic diagram of a link switching method for an enhanced multi-link single radio STA according to embodiments of the present disclosure. As shown in FIG. 5, the enhanced multi-link single radio STA simultaneously senses channel states on a link 1 and a link 2, and if the channel on the link 1 is busy, and the channel on the link 2 is idle, then the link 2 is selected to transmit data (or other types of PPDUs).

802.11be EMLMR: a multi-link device supporting dynamic adjustment of the number of antennas on each link is referred to as an enhanced multi-link multi-radio (EMLMS) device. Compared with a multi-link non-AP MLD with a fixed number of antennas on each link, the enhanced multi-link multi-radio device is more flexible to adapt to different application scenarios.

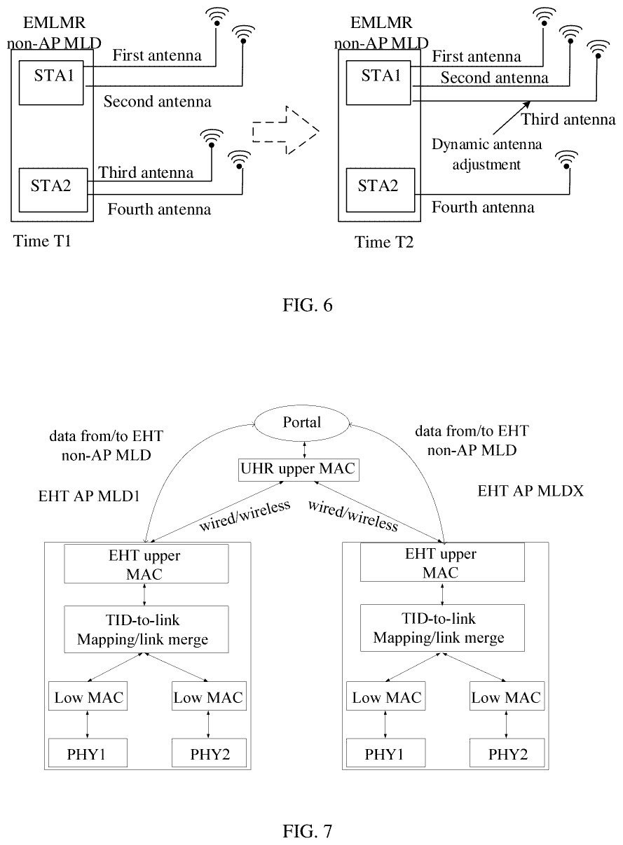

FIG. 6 is a schematic diagram of dynamic antenna adjustment for an EMLMR non-AP MLD according to embodiments of the present disclosure. As shown in FIG. 6, an enhanced multi-link device has four antennas in total on two links; and at time T1, the antenna configuration on the two links is 2:2, and at time T2, the antenna allocation scheme is 3:1, that is, the antenna 3 on the link 2 is allocated to the link 1. Upon establishing a connection with the AP MLD, the EMLMR non-AP MLD needs to perform message interaction with the AP MLD in advance when dynamically adjusting the number of antennas on each link, so that the EMLMR non-AP MLD and the AP MLD can update information such as the number of spatial streams and a transmission rate on each link in a timely manner.

Since dynamic antenna adjustment is relatively complex in implementations, the current protocol stipulates that the PPDU can only be transmitted on one link at a time, which is similar to the PPDU transmission mode of the EMLSR non-AP MLD.

TWT (target wake time) technology: which first appeared in the 802.11ah “Wi-Fi Hallow” standard, and is configured to support energy-saving work in a large-scale Internet of Things environment. With the development of the IEEE 802.11ax standard, the functionality of the TWT has been further expanded, so that the IEEE 802.11ax standard can further optimize the energy-saving mechanism of devices, providing a more reliable and energy-efficient transmission mechanism. In 802.11ax, the TWT mechanism has been modified to support trigger-based uplink transmission on the basis of 802.11ah, thereby expanding the scope of TWT operation.

The basic principle of the TWT is that a terminal STA and an AP negotiate a time service period, and after the service period expires, the terminal wakes up, waits for a trigger frame transmitted by the AP, and performs data exchange once; or competes for a channel by means of an EDCA mechanism, and transmits data to the AP. The terminal returns to the sleep state after the current transmission is completed.

Each terminal performs independent negotiation with an AP, and each terminal has an individual TWT time period, and this manner is also referred to as an individual TWT (i-TWT). The AP may also group a plurality of terminals according to a set TWT time period, and connect to a plurality of terminals at a time, thereby increasing the energy-saving efficiency, and this manner is also referred to as a broadcast TWT (b-TWT).

The 802.11be protocol is further extended based on the b-TWT, and introduces restricted TWT (r-TWT) for low-latency data transmission, aiming to reduce the transmission latency of a low-latency service.

IEEE establishes an ultra high reliability (UHR) study group (SG), and proposes that the task of the SG is to study the evolution direction of a next generation (Wi-Fi 8) technology, and plans to establish an 802.11bn work group and draft the definition of a Wi-Fi 8 protocol. Non-collocated AP MLD, as an alternative technology of Wi-Fi 8, is characterized in that affiliated APs of a same AP MLD are deployed at different locations, thereby solving the latency problem occurring during device-end roaming. In addition, the channel utilization problem is solved by means of cooperation of a plurality of affiliated APs.

Related proposals of the TWT technology include: a Non-collated AP MLD defined by 231r0 (Thoughts on Seamless Roaming Under the Non-collocated AP MLD Architecture), that is, one UHR AP MLD includes a plurality of EHT AP MLDs deployed on different physical device nodes and one UHR upper MAC. As shown in FIG. 7, an architecture diagram of a UHR AP MLD with an integrated UHR upper MAC is provided. In the architecture diagram shown in FIG. 7, the UHR non-AP MLD can establish a link connection with a low MAC of any node without needing to switch a connected network, thereby solving the latency problem caused by network switching.

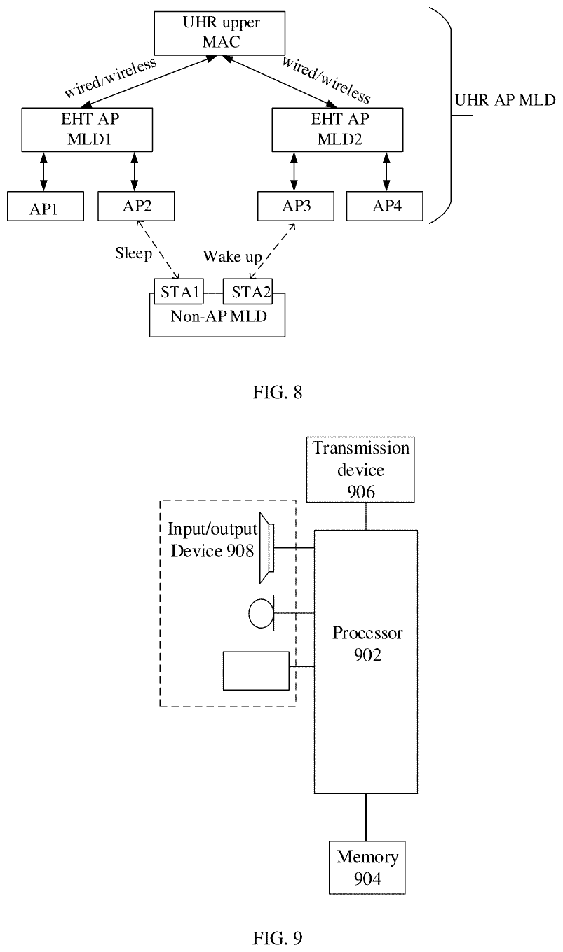

In addition, 632r1 (Smooth Roaming Follow Up) discusses a PPDU transmission method employed after an NSTR/EMLSR/EMLMR non-AP MLD establishes a multi-link connection across AP MLDs, that is, one link remains in a sleep state, and another link remains in a normal operation (awake) state, so as to solve the problem that the UHR AP MLD may communicate with the NSTR/EMLSR/EMLMR non-AP MLD via only one link at a time. As shown in FIG. 8, a topology diagram of communication between an NSTR/EMLSR/EMLMR non-AP MLD and a UHR AP MLD is provided, and the specific process is shown in FIG. 8.

Further, method embodiments provided in embodiments of the present disclosure may be executed in a computer terminal or a similar computing apparatus. Taking running the method embodiments on a computer terminal as an example, FIG. 9 is a structural block diagram of hardware of a computer terminal for a method for transmitting data unit information according to embodiments of the present disclosure. As shown in FIG. 9, the computer terminal may include one or more (FIG. 9 shows only one processor) processors 902 (the processor 902 may include, but is not limited to a microprocessor unit (MPU) or a programmable logic device (PLD) and a memory 904 configured to store data. In an exemplary embodiment, the computer terminal may further include a transmission device 906 and an input/output device 908 configured with communication functions. A person of ordinary skill in the art would understand that the structure shown in FIG. 9 is merely exemplary, and does not limit the structure of the computer terminal. For example, the computer terminal may also include more or fewer components than those shown in FIG. 9, or have equal functions as those shown in FIG. 9 or different configurations having more functions than those shown in FIG. 9.

The memory 904 may be configured to store a computer program, for example, a software program and modules of application software, such as a computer program corresponding to the method for transmitting data unit information according to embodiments of the present disclosure. The processor 902 executes various functional applications and data processing by running the computer program stored in the memory 904, i.e. implementing the described method. The memory 904 may include a high-speed random access memory, and may further include a non-transitory memory, such as one or more magnetic storage devices, flash memories or other non-transitory solid-state memories. In some examples, the memory 904 may further include memories remotely arranged with respect to the processors 902, and these remote memories may be connected to the computer terminal via a network. Examples of the network include, but are not limited to the Internet, an intranet, a local area network, a mobile communication network and combinations thereof.

The transmission device 906 is configured to receive or transmit data via a network. Specific examples of the network may include a wireless network provided by a communication provider of the computer terminal. In one example, the transmission device 906 includes a network interface controller (NIC), which may be connected with other network devices by means of a base station, thus may be able to communicate with the Internet. In one example, the transmission device 906 may be a radio frequency (RF) module, which is configured to communicate with the Internet in a wireless manner.

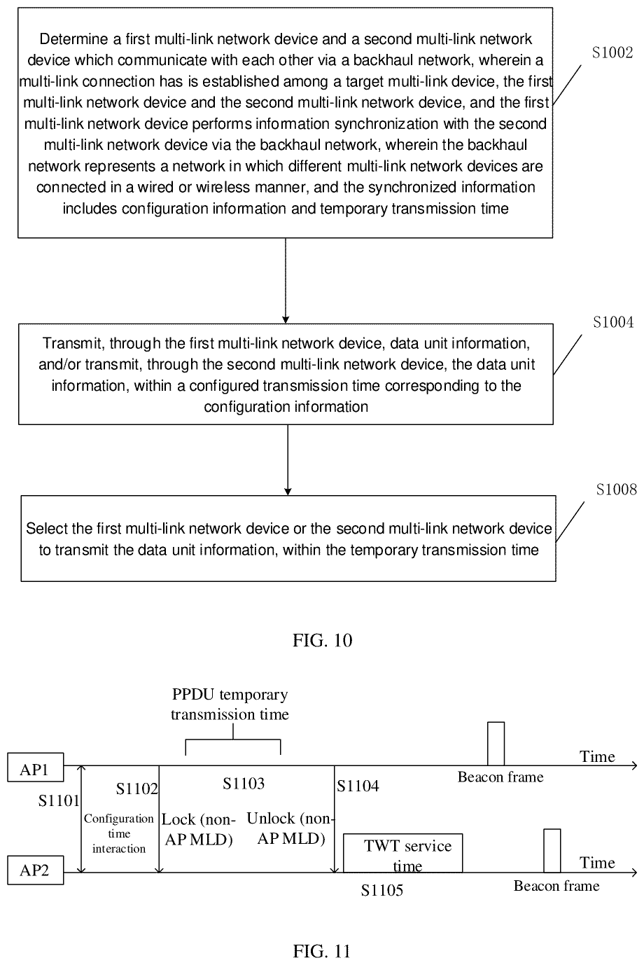

FIG. 10 is a flowchart of a method for transmitting data unit information according to embodiments of the present disclosure. As shown in FIG. 10, the steps of the method include:
step S1002: determine a first multi-link network device and a second multi-link network device which communicate with each other via a backhaul network, wherein a multi-link connection is established among a target multi-link device, the first multi-link network device and the second multi-link network device, and the first multi-link network device is configured to perform information synchronization with the second multi-link network device via the backhaul network, the backhaul network represents a network in which different multi-link network devices are connected in a wired or wireless manner, and the synchronized information includes configuration information and temporary transmission time.

It should be noted that, different multi-link network devices in the backhaul network are directly or indirectly connected with each other in a wired or wireless manner. Optionally, the backhaul network may represent a network that directly or indirectly connects different multi-link network devices in a wired manner, and may also represent a network that directly or indirectly connects different multi-link network devices in a wireless manner.
Step S1004: within a configured transmission time corresponding to the configuration information, transmit, by the first multi-link network device, data unit information, and/or, transmit, by the second multi-link network device, the data unit information.
Step S1006: select the first multi-link network device or the second multi-link network device to transmit the data unit information, within the temporary transmission time.

Optionally, in the above steps, for example, a multi-link connection may be established with a non-AP MLD to connect two links (APs), respective configured time and period information (configuration information) are transmitted on a backhaul network, and in the configuration information, respective downlink PPDUs are transmitted from their corresponding links.

Optionally, in the above embodiments, for example, a temporary transmission time period may be negotiated in addition to the configuration information, and within the time period, only one link is configured to transmit data.

In some embodiments of the present disclosure, a first multi-link network device and a second multi-link network device which communicate with each other via a backhaul network are determined, wherein a multi-link connection is established among a target multi-link device, the first multi-link network device and the second multi-link network device, and the first multi-link network device is configured to perform information synchronization with the second multi-link network device via the backhaul network; the backhaul network represents a network in which different multi-link network devices are connected in a wired or wireless manner, and the synchronized information includes configuration information and temporary transmission time; within a configured transmission time corresponding to the configuration information, data unit information is transmitted by the first multi-link network device, and/or data unit information is transmitted by the second multi-link network device; and within the temporary transmission time, the first multi-link network device or the second multi-link network device is selected to transmit the data unit information. The present disclosure solves the technical problem of how to transmit data unit information on a plurality of links between a UHR AP MLD and a non-AP MLD.

In an exemplary embodiment, the configuration information includes first configuration information between the target multi-link device and the first multi-link network device, and/or second configuration information between the target multi-link device and the second multi-link network device. within a configured transmission time corresponding to the configuration information in the step S1004, transmitting data unit information by the first multi-link network device, and/or transmitting data unit information by the second multi-link network device specifically include following steps: within a configured transmission time corresponding to the first configuration information, transmitting the data unit information to a target multi-link device through a first network link where the first multi-link network device is located, wherein the first network link represents a link between the first multi-link network device and the target multi-link device; and/or within a configuration transmission time corresponding to the second configuration information, transmitting the data unit information to a target multi-link device through a second network link where the second multi-link network device is located, wherein the second network link represents a link between the second multi-link network device and the target multi-link device.

In an exemplary embodiment, the step S1006 may include the following implementation solutions: in a case where it is determined that the second multi-link network device receives a first synchronization signal transmitted by the first multi-link network device, acquiring a first temporary transmission time received by the second multi-link network device when receiving the first synchronization signal, and selecting the first multi-link network device to transmit the data unit information within the first temporary transmission time; in a case where it is determined that the second multi-link network device receives a second synchronization signal transmitted by the first multi-link network device after the first multi-link network device transmits the data unit information within the first temporary transmission time, then transmission of the data unit information by the second multi-link network device is recovered according to the second synchronization signal; and in a case where it is determined that the second multi-link network device does not receive the second synchronization signal transmitted by the first multi-link network device after the first multi-link network device transmits the data unit information within the first temporary transmission time, then the second multi-link network device autonomously recovers transmission of the data unit information.

In an exemplary embodiment, the step S1006 may further include other implementation solutions: in a case where it is determined that the first multi-link network device receives a third synchronization signal transmitted by the second multi-link network device, acquiring a second temporary transmission time received by the first multi-link network device when receiving the third synchronization signal, and selecting the second multi-link network device to transmit the data unit information within the second temporary transmission time; in a case where it is determined that the first multi-link network device receives a fourth synchronization signal transmitted by the second multi-link network device after the second multi-link network device transmits the data unit information within the second temporary transmission time, then transmission of the data unit information by the first multi-link network device is recovered according to the fourth synchronization signal; and in a case where it is determined that the first multi-link network device does not receive the fourth synchronization signal transmitted by the second multi-link network device after the second multi-link network device transmits the data unit information within the second temporary transmission time, then the first multi-link network device autonomously recovers transmission of the data unit information.

In an exemplary embodiment, in order to better understand the implementation process in which the first multi-link network device is configured to perform information synchronization with the second multi-link network device via the backhaul network in the step S1002, the following steps are further proposed: in a case where it is determined that a link state of the multi-link connection changes, the first multi-link network device is configured to perform information synchronization with the second multi-link network device via the backhaul network; and in a case where first configuration information between the target multi-link device and the first multi-link network device and/or second configuration information between the target multi-link device and the second multi-link network device changes, the first multi-link network device is configured to perform information synchronization with the second multi-link network device via the backhaul network.

In an exemplary embodiment, the configuration information represents target beacon transmission time information and/or delivery traffic indication map information of network links included in the multi-link connection.

Optionally, in the above embodiments, for example, the configuration information may be target beacon frame transmission time (TBTT) information and/or delivery traffic indication map (DTIM) information of two links.

In an exemplary embodiment, the configuration information represents a target wake time on network links included in the multi-link connection, wherein the target wake time includes at least one of restricted target wake time, broadcast target wake time, and individual target wake time.

Optionally, in the above embodiments, for example, the configuration information may be TWT (Target Wake Time) information of a non-AP MLD on two links, including r-TWT (restricted TWT) information, b-TWT (broadcast TWT) information, and i-TWT (individual TWT) information.

In an exemplary embodiment, it may be determined that first configuration information between the target multi-link device and the first multi-link network device and/or second configuration information between the target multi-link device and the second multi-link network device changes by following operations: in a case where it is determined that target beacon transmission time information of a first network link changes, then it is determined that first configuration information between the target multi-link device and the first multi-link network device changes, wherein the first network link represents a link between the first multi-link network device and the target multi-link device; and/or in a case where it is determined that target beacon transmission time information of a second network link changes, then it is determined that second configuration information between the target multi-link device and the second multi-link network device changes, wherein the second network link represents a link between the second multi-link network device and the target multi-link device.

Optionally, in the above embodiments, when the configuration information and/or link state information on a link changes, AP1 and AP2 are caused to interact again to obtain new configuration information.

In an exemplary embodiment, it may be determined that first configuration information between the target multi-link device and the first multi-link network device and/or second configuration information between the target multi-link device and the second multi-link network device changes by following operations: in a case where it is determined that the target wake time of network links included in the multi-link connection changes, then it is determined that the first configuration information between the target multi-link device and the first multi-link network device and/or the second configuration information between the target multi-link device and the second multi-link network device changes, wherein the network links included in the multi-link connection include at least one of a first network link and a second network link, the first network link represents a link between the first multi-link network device and the target multi-link device, and the second network link represents a link between the second multi-link network device and the target multi-link device.

In an exemplary embodiment, it may be determined that the target wake time on network links included in the multi-link connection changes by one of following operations: in a case where it is determined that the target multi-link device joins or exits a restricted target wake time group and/or a broadcast target wake time group of the first multi-link network device on the first network link, when it is detected that a restricted target wake time and/or a broadcast target wake time of the first network link changes, then it is determined that a target wake time of network links included in the multi-link connection changes; in a case where it is determined that the target multi-link device creates or deletes a restricted target wake time group and/or a broadcast target wake time group of the second network link on the second network link, it is determined that a target wake time of network links included in the multi-link connection changes; and in a case where it is determined that an individual target wake time group of network links included in the multi-link connection is created or adjusted, when it is detected that an individual target wake time of network links included in the multi-link connection changes, then it is determined that a target wake time of network links included in the multi-link connection changes.

Optionally, in the above embodiments, the change in the configuration information includes a change in TBTT information and a change in TWT information. The change in the TWT information includes but is not limited to: after a non-AP MLD joins/exits the corresponding API on a first link, and/or after the non-AP MLD creates/deletes an r-TWT group and a b-TWT group on an AP2 of the second link, r-TWT information and/or b-TWT information changes; and after negotiating the creation/deletion/update of an i-TWT group, i-TWT information changes, for example, the start time and duration.

In an exemplary embodiment, it is determined that the link state of the multi-link connection changes by at least one of following operations: for any network link included in the multi-link connection, it is determined that the link state of the multi-link connection changes in a case where it is determined that any one of the following conditions is met: the network link is deleted, the network link is a newly added, the network link enters a sleep state, or the network link is disabled, then; and for the multi-link connection, in a case where it is determined that a base station end of a target multi-link device of the multi-link connection enters a sleep state, then it is determined that the link state of the multi-link connection changes.

Optionally, in the above embodiments, the change in the link state of the multi-link connection includes but is not limited to: the link is about to be deleted; the link is a newly added link; the link enters a sleep state; the link is disabled; and an STA corresponding to the Non-AP MLD on this link enters a sleep state.

In an exemplary embodiment, the technical solution in which the first multi-link network device is configured to perform information synchronization with the second multi-link network device via the backhaul network in the step S1002 may further include the following implementation steps: the first multi-link network device transmits a fifth synchronization signal to the second multi-link network device, and in a case where it is determined that the first multi-link network device receives a response signal transmitted by the second multi-link network device based on the fifth synchronization signal, it is determined that information synchronization is successful, wherein the fifth synchronization signal is a bidirectional signal; and/or the first multi-link network device transmits a sixth synchronization signal to the second multi-link network device, then it is determined that information synchronization is successful, wherein the sixth synchronization signal is a unidirectional signal.

Optionally, in the above embodiments, the first multi-link network device performs information synchronization with a second multi-link network device by means of a synchronization signal via a backhaul network. The synchronization signal may be a bidirectional signal; for example, on a backhaul link, after transmitting a lock/unlock signal to AP2, AP1 needs to wait for AP2 to transmit a corresponding response signal to complete signal synchronization. The synchronization signal may also be a unidirectional signal; for example, after transmitting a lock/unlock signal to AP2, AP1 does not need to wait for AP2 to transmit a corresponding response signal.

Optionally, in the above embodiments, for example, AP1 may transmit time information to AP2 for transmitting a PPDU to a non-AP MLD, wherein the time information includes but is not limited to: start time; duration/end time; and period information.

In an exemplary embodiment, in a case where it is determined that the second multi-link network device receives a seventh synchronization signal transmitted by the first multi-link network device, acquiring a third temporary transmission time received by the second multi-link network device when receiving the seventh synchronization signal; starting timing from a reception time of the seventh synchronization signal to obtain a first timing time; and in a case where it is determined that a difference between the first timing duration and the third temporary transmission time is less than a preset threshold, and the second multi-link network device does not receive an eighth synchronization signal transmitted by the first multi-link network device, an unlocking signal is transmitted to the second multi-link network device by the second multi-link network device, so that the second multi-link network device recovers transmission of the data unit information based on the unlocking signal.

Optionally, in the above embodiments, for example, on a backhaul network, if a link 2 (AP2) receives a lock (non-AP MLD) signal from a link 1 (AP1), but does not receive an unlock (non-AP MLD) signal from AP1 before the expiration time expires, AP2 transmits an unlock (non-AP MLD) signal to itself for unlocking.

In an exemplary embodiment, further, in a case where it is determined that the second multi-link network device receives a ninth synchronization signal transmitted by the first multi-link network device, acquiring a fourth temporary transmission time received by the second multi-link network device when receiving the ninth synchronization signal; starting timing from a reception time of the ninth synchronization signal to obtain a second timing duration; and keeping the second multi-link network device turned off in a case where any of the following conditions is met: it is determined that a difference between the second timing duration and the fourth temporary transmission time is less than a preset threshold, or it is determined that the difference between the second timing duration and the fourth temporary transmission time is greater than the preset threshold, and the second multi-link network device does not receive a tenth synchronization signal transmitted by the first multi-link network device.

Optionally, in the above embodiments, for example, on a backhaul network, a link 2 (AP2) receives a lock (non-AP MLD) signal from a link 1 (AP1), but before the expiration time expires or before an unlock (non-AP MLD) signal is received, the link 2 is kept in a disabled state, so as to save power.

In an exemplary embodiment, network links included in the multi-link connection belong to a same multi-link network device, or the network links included in the multi-link connection belong to different multi-link network devices.

Optionally, in the above embodiments, for example, a link 1 (AP1) and a link 2 (AP2) of a UHR AP MLD may belong to the same EHT AP MLD, and may also belong to different EHT AP MLDs.

In an exemplary embodiment, multi-link connection may be established among network links included in the multi-link connection and target multi-link devices of a plurality of non-asynchronous multi-links, and at least one eleventh synchronization signal is transmitted to the target multi-link devices of the plurality of non-asynchronous multi-links through the multi-link network device on any network link, wherein the at least one eleventh synchronization signal includes at least one synchronization signal directed to the target multi-link devices of the plurality of non-asynchronous multi-links.

Optionally, in the above embodiments, for example, multi-link connection may be established among a link 1 (AP1) and a link 2 (AP2) establish, and non-AP MLDs (NSTR AP MLD, EMLSR AP MLD, EMLMR AP MLD) of the plurality of non-asynchronous multi-links, and when AP1 simultaneously transmits data to the plurality of non-AP MLDs (non-AP MLD1, non-AP MLD2), a synchronization signal transmitted by AP1 to AP2 includes a plurality of non-AP MLDs, for example, lock/unlock (non-AP MLD1, non-AP MLD2) signal.

In order to better understand the method for transmitting data unit information, the method will be described below in conjunction with embodiments, which are not intended to limit the technical solutions of the embodiments of the present disclosure, and optionally:
in an optional embodiment, FIG. 11 is a schematic flowchart of negotiating a transmission time period between two links according to embodiments of the present disclosure. The method for transmitting data unit information according to the present embodiment will be described below with reference to FIG. 11, and the specific steps are as follows:
Step S1101: after the first multi-link terminal (non-AP MLD) establishes a multi-link connection with a UHRAP MLD on at least two links (STA1, STA2) via AP1 and AP2 respectively, AP1 and AP2 notify, via a backhaul network, each other of respective configuration information with the non-AP MLD.
Step S1102: outside a time period window corresponding to the configuration information, AP1 or AP2 selects a temporary transmission time for transmitting a PPDU to the non-AP MLD, and AP1 transmits a synchronization signal lock (non-AP MLD) and an expiration time (i.e. a temporary transmission time duration) of the signal to AP2, and AP2 transmits a synchronization signal lock and an expiration time of the signal to AP1.
Step S1103: after receiving the synchronization signal and the expiration time, AP2 or AP1 does not transmit the PPDU to the non-AP MLD from the link before the expiration time expires.
Step S1104: after AP1 or AP2 transmits the PPDU to the non-AP MLD by means of STA1 or STA2 on a first link or a second link, AP1 transmits a synchronization signal unlock (non-AP MLD) to AP2, or AP2 transmits a synchronization signal unlock (non-AP MLD) to AP1.
Step S1105: within the time window corresponding to the configuration information, AP1 or AP2 directly transmits the PPDU to the non-AP MLD by means of the STA1 or STA2 on the first link or the second link, without needing to transmit a synchronization signal.
Step S1106: steps S1102 to S1105 are repeated.

In the above embodiment, each UHR AP MLD consists of one UHR upper MAC and a plurality of EHT AP MLDs located at different physical locations. The EHT AP MLDs establish a backhaul network with the UHR upper MAC in a wired or wireless manner. Based on this, the described steps illustrate a method in a UHR AP MLD architecture, when the non-AP MLD operates in an NSTR/EMLSR/EMLMS mode, after the non-AP MLD establishes a multi-link connection with the UHR AP MLD, multiple links of the UHR AP MLD negotiate for a time period to transmit a downlink PPDU to the non-AP MLD. That is, two links (APs) are connected with each other by establishing a multi-link connection with the non-AP MLD, respective configuration time and period information are respectively transmitted on the backhaul network, and within the configuration information, respective downlink PPDUs are transmitted from their corresponding links; outside the configuration information, a temporary transmission time period is negotiated, and within the time period, only one link is used to transmit data; and when the link state or configuration information changes, two APs re-synchronize new configuration information to enable the UHR AP MLD to transmit data to the non-AP MLD from a plurality of links.

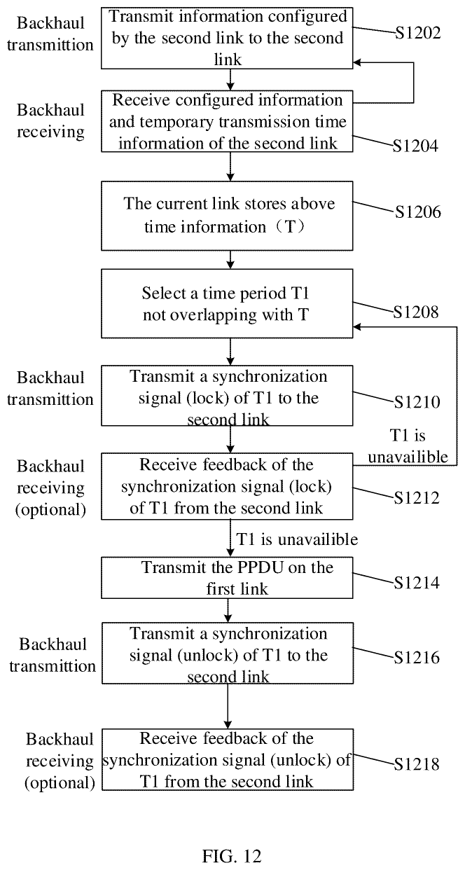

In some optional embodiments, FIG. 12 is a schematic flowchart of a first link on a backhaul network according to embodiments of the present disclosure. The procedures of the AP1 and AP2 on a backhaul network according to the present embodiment will be described below with reference to FIG. 12, and the specific steps are as follows:
Step S1202: transmit a request for configuration information to an AP2 located on a second link.
Step S1204: receive the request for configuration information transmitted by AP2.
Step S1206: receive a temporary transmission time request from AP2 and a corresponding synchronization signal.
Step S1208: store locally the latest time information of the current link and time information of the second link, and they are recorded as a set T.
Step S1210: before a PPDU is transmitted to a non-AP MLD, a time period is selected outside a time window corresponding to the set T, and is recorded as T1.
Step S1212: transmit a synchronization signal (lock) of T1 to AP2.
Step S1214: receive feedback information of the synchronization signal (lock) of T1 from AP2, and if the feedback information indicates that T1 is available, compete for a channel and transmit the PPDU to the non-AP MLD on a first link; and if the feedback information indicates that T1 is unavailable, return to step S1208.
Step S1216: transmit a synchronization signal (unlock) of T1 to AP2.
Step S1218: receive feedback information of the synchronization signal (lock) of T1 from AP2.

It should be noted that, the transmitting and receiving processes in the described steps are both backhaul transmitting and backhaul receiving, and steps S1214 and S1218 are optional steps.

Optionally, in the above embodiments, a trigger condition for synchronizing time information to the second link includes but is not limited to: configuration information on the current link is updated; or the state of the current link changes.

Optionally, in the above embodiments, a triggering conditions for the second link to synchronize time information to the current link includes but is not limited to: configuration information on the second link is updated; the state of the second link changes; the second link synchronizes a downlink PPDU transmission signal to the current link, that is, AP2 transmits downlink data to the non-AP MLD on the second link; and the second link synchronizes an uplink PPDU transmission signal to the current link, that is, AP2 receives uplink data transmitted by the non-AP MLD on the second link.

Optionally, in the above embodiments, the situation where the second link feeds back that T1 is unavailable includes but is not limited to: the non-AP MLD is transmitting the PPDU on the second link.

It can be clearly determined from the above embodiments that the technical solutions of the present disclosure include the following key technical features:
1. two APs that establish a multi-link connection with a non-AP MLD respectively transmit respective link configuration information on a backhaul network, and respectively transmit their respective downlink PPDUs to the non-AP MLD from their corresponding links within a time window corresponding to the configuration information;
2. outside the configuration information, a temporary transmission time period is synchronized, and within the time period, only one link is used to transmit data to the non-AP MLD;
3. when the link state or configuration information changes, the two APs re-transmit configuration information on the backhaul network;
4. when the link configuration information and/or the link state changes, the new configuration information is transmitted to AP2 located on a second link via the backhaul network;
5. taking AP1 (link 1) as an example, a request for configuration information and temporary transmission time transmitted by AP2 located on the second link is received from the backhaul network;
6. taking AP1 (link 1) as an example, the latest configuration information of the current link, and time information and temporary transmission time information of the second link are stored locally, and are recorded as a set T; and before the PPDU is transmitted to the non-AP MLD, a time period not overlapping with T is selected outside the set T, and is recorded as T1; and
7. taking AP1 (link 1) as an example, a synchronization signal (lock/unlock) for non-AP MLD and T1 is transmitted to the second link.
Further, the present embodiment further provides an apparatus for transmitting data unit information. The apparatus is configured to implement the above embodiments and preferred embodiments, and what has been described will not be repeated again. As used below, the term “module” may be implemented as a combination of software and/or hardware of predetermined functions. Although the device described in the embodiments below is preferably implemented in software, implementation of the device in hardware or a combination of software and hardware is also possible and could have been conceived.

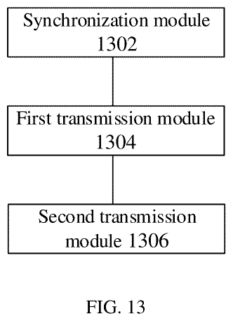

FIG. 13 is a structural block diagram of an apparatus for transmitting data unit information according to embodiments of the present disclosure. As shown in FIG. 13, the apparatus for transmitting data unit information includes:
a synchronization module 1302, configured to determine a first multi-link network device and a second multi-link network device which communicate with each other via a backhaul network, wherein a multi-link connection is established among a target multi-link device, the first multi-link network device and the second multi-link network device, and the first multi-link network device is configured to perform information synchronization with the second multi-link network device via the backhaul network, the backhaul network represents a network in which different multi-link network devices are connected in a wired or wireless manner, and the synchronized information includes configuration information and temporary transmission time;
a first transmission module 1304, configured to transmit, through the first multi-link network device, data unit information, and/or transmit, through the second multi-link network device, data unit information, within a configured transmission time corresponding to the configuration information; and
a second transmission module 1306, configured to select the first multi-link network device or the second multi-link network device to transmit the data unit information, within the temporary transmission time.

By means of the described apparatus, a first multi-link network device and a second multi-link network device which communicate with each other via a backhaul network are determined, wherein a multi-link connection is established among a target multi-link device, the first multi-link network device and the second multi-link network device, and the first multi-link network device is configured to perform information synchronization with the second multi-link network device via the backhaul network, the backhaul network represents a network in which different multi-link network devices are connected in a wired or wireless manner, and the synchronized information includes configuration information and temporary transmission time; within a configured transmission time corresponding to the configuration information, data unit information is transmitted through the first multi-link network device, and/or data unit information is transmitted through the second multi-link network device; and within the temporary transmission time, the first multi-link network device or the second multi-link network device is selected to transmit the data unit information. The present disclosure solves the technical problem of how to transmit data unit information on a plurality of links between a UHR AP MLD and a non-AP MLD.

In an optional embodiment, the configuration information includes first configuration information between the target multi-link device and the first multi-link network device, and/or second configuration information between the target multi-link device and the second multi-link network device. The first transmission module 1304 is further configured to: transmit the data unit information to a target multi-link device through a first network link where the first multi-link network device is located within a configured transmission time corresponding to the first configuration information, wherein the first network link represents a link between the first multi-link network device and the target multi-link device; and/or transmit the data unit information to a target multi-link device through a second network link where the second multi-link network device is located within a configured transmission time corresponding to the second configuration information, wherein the second network link represents a link between the second multi-link network device and the target multi-link device.

In an optional embodiment, the second transmission module 1306 is further configured to: in a case where it is determined that the second multi-link network device receives a first synchronization signal transmitted by the first multi-link network device, acquire a first temporary transmission time received by the second multi-link network device when receiving the first synchronization signal, and select the first multi-link network device to transmit the data unit information within the first temporary transmission time; in a case where it is determined that the second multi-link network device receives a second synchronization signal transmitted by the first multi-link network device after the first multi-link network device transmits the data unit information within the first temporary transmission time, recovering, according to the second synchronization signal, transmission of the data unit information by the second multi-link network device; and iin a case where it is determined that the second multi-link network device does not receive the second synchronization signal transmitted by the first multi-link network device after the first multi-link network device transmits the data unit information within the first temporary transmission time, then autonomously recover, transmission of the data unit information by the second multi-link network device.

In an optional embodiment, the second transmission module 1306 is further configured to: select the second multi-link network device to transmit the data unit information within the temporary transmission time, which includes: in a case where it is determined that the first multi-link network device receives a third synchronization signal transmitted by the second multi-link network device, acquiring a second temporary transmission time received by the first multi-link network device when receiving the third synchronization signal, and selecting the second multi-link network device to transmit the data unit information within the second temporary transmission time; in a case where it is determined that the first multi-link network device receives a fourth synchronization signal transmitted by the second multi-link network device after the second multi-link network device transmits the data unit information within the second temporary transmission time, then transmission of the data unit information by the first multi-link network device is recovered according to the fourth synchronization signal; and in a case where it is determined that the first multi-link network device does not receive the fourth synchronization signal transmitted by the second multi-link network device after the second multi-link network device transmits the data unit information within the second temporary transmission time, then the first multi-link network device autonomously recovers transmission of the data unit information.

In an optional embodiment, the synchronization module 1302 is further configured such that: in a case where it is determined that a link state of the multi-link connection changes, the first multi-link network device is configured to perform information synchronization with the second multi-link network device via the backhaul network; and in a case where first configuration information between the target multi-link device and the first multi-link network device and/or second configuration information between the target multi-link device and the second multi-link network device changes, the first multi-link network device is configured to perform information synchronization with the second multi-link network device via the backhaul network.

In an optional embodiment, the configuration information represents target beacon transmission time information and/or delivery traffic indication map information of network links included in the multi-link connection.

In an optional embodiment, the configuration information represents a target wake time on network links included in the multi-link connection, wherein the target wake time includes at least one of restricted target wake time, broadcast target wake time, and individual target wake time.

In an optional embodiments, the apparatus for transmitting data unit information further includes a determination module, configured to determine, by the following operations, that first configuration information between the target multi-link device and the first multi-link network device and/or second configuration information between the target multi-link device and the second multi-link network device changes: in a case where it is determined that target beacon transmission time information of a first network link changes, then it is determined that first configuration information between the target multi-link device and the first multi-link network device changes, wherein the first network link represents a link between the first multi-link network device and the target multi-link device; and/or in a case where it is determined that target beacon transmission time information of a second network link changes, then it is determined that the second configuration information between the target multi-link device and the second multi-link network device changes, wherein the second network link represents a link between the second multi-link network device and the target multi-link device.

In an optional embodiment, the determination module 1306 is further configured to: if it is determined that a target wake time of network links included in the multi-link connection changes, determine that the first configuration information between a target multi-link device and the first multi-link network device and/or the second configuration information between the target multi-link device and the second multi-link network device changes, wherein the network links included in the multi-link connection include at least one of the following: a first network link and a second network link, the first network link represents a link between the first multi-link network device and the target multi-link device, and the second network link represents a link between the second multi-link network device and the target multi-link device.

In an optional embodiment, the determination module 1306 is further configured to: in a case where it is determined that the target multi-link device joins or exits a restricted target wake time group and/or a broadcast target wake time group of the first multi-link network device on the first network link, when it is detected that a restricted target wake time and/or a broadcast target wake time of the first network link changes, determine that a target wake time of network links included in the multi-link connection changes; in a case where it is determined that the target multi-link device creates or deletes a restricted target wake time group and/or a broadcast target wake time group of the second network link on the second network link, determine that a target wake time of network links included in the multi-link connection changes; and in a case where it is determined that an individual target wake time group of network links included in the multi-link connection is created or adjusted, when it is detected that an individual target wake time of network links included in the multi-link connection changes, then determine that a target wake time of network links included in the multi-link connection changes.

In an optional embodiment, the synchronization module 1302 is further configured to: determine, by at least one of the following means, that the link state of the multi-link connection changes: for any network link included in the multi-link connection, it is determined that the link state of the multi-link connection changes in a case where it is determined that any one of the following conditions is met: the network link is deleted, the network link is a link newly added, the network link enters a sleep state, or the network link is disabled; and for the multi-link connection, in a case where it is determined that a base station end of the target multi-link device of the multi-link connection enters a sleep state, it is determined that the link state of the multi-link connection changes.

In an optional embodiment, the synchronization module 1302 is further configured to: transmit, by the first multi-link network device, a fifth synchronization signal to the second multi-link network device, and in a case where it is determined that the first multi-link network device receives a response signal transmitted by the second multi-link network device based on the fifth synchronization signal, determine that information synchronization is successful, wherein the fifth synchronization signal is a bidirectional signal; and/or transmit, by the first multi-link network device, a sixth synchronization signal to the second multi-link network device, then determine that the information synchronization is successful, wherein the sixth synchronization signal is a unidirectional signal.

In an optional embodiment, the apparatus for transmitting data unit information further includes a third transmission module, configured to: in a case where it is determined that the second multi-link network device receives a seventh synchronization signal transmitted by the first multi-link network device, acquire a third temporary transmission time received by the second multi-link network device when receiving the seventh synchronization signal; start timing from a reception time of the seventh synchronization signal to obtain a first timing duration; and in a case where it is determined that a difference between the first timing duration and the third temporary transmission time is less than a preset threshold, and the second multi-link network device does not receive an eighth synchronization signal transmitted by the first multi-link network device, transmit an unlocking signal to the second multi-link network device by the second multi-link network device, so that the second multi-link network device recovers transmission of the data unit information based on the unlocking signal.

In an optional embodiment, the apparatus for transmitting data unit information further includes a fourth transmission module, configured to: in a case where it is determined that the second multi-link network device receives a ninth synchronization signal transmitted by the first multi-link network device, acquire a fourth temporary transmission time received by the second multi-link network device while receiving the ninth synchronization signal; start timing from a reception time of the ninth synchronization signal to obtain a second timing duration; and keep the second multi-link network device turned off if any of the conditions is met: it is determined that a difference between the second timing duration and the fourth temporary transmission time is less than a preset threshold, or if it is determined that a difference between the second timing duration and the fourth temporary transmission time is greater than the preset threshold, and the second multi-link network device does not receive a tenth synchronization signal transmitted by the first multi-link network device.

In an optional embodiment, network links included in the multi-link connection belong to a same multi-link network device, or the network links included in the multi-link connection belong to different multi-link network devices.

In an optional embodiment, the apparatus for transmitting data unit information further includes a fifth transmission module, configured to establish, among network links included in the multi-link connection and target multi-link devices of a plurality of non-asynchronous multi-links, multi-link connection; and at least one eleventh synchronization signal is transmitted to the target multi-link devices of the plurality of non-asynchronous multi-links through a multi-link network device on any network link, wherein the at least one eleventh synchronization signal includes at least one synchronization signal directed to the target multi-link devices of the plurality of non-asynchronous multi-links.

From the description of the above embodiments, a person skilled in the art would be able to clearly understand that the method according to the embodiments above may be implemented by using software and necessary general hardware platforms, and of course may also be implemented using hardware, but in many cases, the former is a better implementation. Based on such understanding, the portion of the technical solution of the present disclosure that contributes in essence or to the related art may be embodied in the form of a software product. The computer software product is stored in a readable storage medium (such as a ROM/RAM, a magnetic disk and an optical disc), and includes several instructions to cause a terminal device (which may be a mobile phone, a computer, a server or a network device, etc.) to execute the method according to the embodiments of the present disclosure.

In some exemplary embodiments, the computer-readable storage medium may include, but is not limited to: various media that can store a computer program, such as a USB flash drive, a read-only memory (ROM), a random access memory (RAM), a portable hard disk, a magnetic disk, or an optical disc.

For specific examples in the present embodiment, reference may be made to the examples described in the embodiments and exemplary implementations, and thus they will not be repeated again in the present embodiment.

Embodiments of the present disclosure further provide an electronic device, including a memory and a processor, wherein the memory stores a computer program, and the processor is configured to execute the computer program to implement the steps in any one of the method embodiments above.

Optionally, in the present embodiment, the processor may be configured to execute the following steps by means of the computer program:
S1: determine a first multi-link network device and a second multi-link network device which communicate with each other via a backhaul network, wherein a multi-link connection is established among a target multi-link device, the first multi-link network device and the second multi-link network device, and the first multi-link network device is configured to perform information synchronization with the second multi-link network device via the backhaul network, the backhaul network represents a network in which different multi-link network devices are connected in a wired or wireless manner, and the synchronized information includes configuration information and temporary transmission time.
S2: Within a configured transmission time corresponding to the configuration information, transmit data unit information by the first multi-link network device, and/or transmit data unit information by the second multi-link network device.
S3: Within the temporary transmission time, select the first multi-link network device or the second multi-link network device to transmit the data unit information.

In some exemplary embodiments, the electronic device may further include a transmission device and an input/output device, wherein the transmission device is connected with the processor, and the input/output device is connected with the processor.

Optionally, in the present embodiment, the electric device may be further be configured to execute steps S1, S2 and S3 by means of a computer program.

For specific examples in the present embodiment, reference can be made to the examples described in the embodiments and exemplary implementations, and thus they will not be repeated again in the present embodiment.

It is apparent that a person skilled in the art shall understand that the modules or steps in the embodiments of the present disclosure may be implemented by means of a general computing device, they may be integrated on a single computing device, or distributed over a network consisting of a plurality of computing devices, and the modules or steps may be implemented by means of program codes executable by a computing device, and thus can be stored in a storage device and executed by a computing device. In addition, in some cases, the steps shown or described may be executed in a sequence different from that shown herein, or the modules or steps can be implemented by manufacturing the modules or steps into integrated circuit modules respectively, or manufacturing multiple modules or steps in the modules or steps into a single integrated circuit module. Thus, the present disclosure is not limited to any specific hardware and software combinations.

The content above merely relates to preferred embodiments of the present disclosure, and is not intended to limit the present disclosure. For a person skilled in the art, the present disclosure may have various modifications and changes. Any modifications, equivalent replacements, improvements, etc. made within the principle of the present disclosure shall all fall within the protection scope of the present disclosure.

What is claimed is:

1. A method for transmitting data unit information, performed by a first multi-link network device, the method comprising:
establishing at least one first network link with a target multi-link device, and performing information synchronization with a second multi-link network device; wherein at least one second network link is established between the target multi-link device and the second multi-link network device; and
transmitting, through at least one of the first multi-link network device or the second multi-link network device, the data unit information within a configured transmission time corresponding to a configuration information.

2. The method for transmitting data unit information according to claim 1, wherein the configuration information comprises at least one of: first configuration information between the target multi-link device and the first multi-link network device, or second configuration information between the target multi-link device and the second multi-link network device; and the transmitting, through at least one of the first multi-link network device or the second multi-link network device, the data unit information, within a configured transmission time corresponding to the configuration information, comprises at least one of:
transmitting, through a first network link, the data unit information to the target multi-link device within a configured transmission time corresponding to the first configuration information, wherein the first network link represents a link between the first multi-link network device and the target multi-link device; or
transmitting, through a second network link, the data unit information to the target multi-link device within a configured transmission time corresponding to the second configuration information, wherein the second network link represents a link between the second multi-link network device and the target multi-link device.

3. The method for transmitting data unit information according to claim 1, wherein the first multi-link network device and the second multi-link network device communicate with each other via a backhaul network, and the first multi-link network device performs information synchronization with the second multi-link network device via the backhaul network; the backhaul network represents a network in which different multi-link network devices are connected in a wired or wireless manner, and the synchronized information comprises configuration information; the method further comprises:
selecting the first multi-link network device or the second multi-link network device to transmit the data unit information, within the temporary transmission time.

4. The method for transmitting data unit information according to claim 3, wherein the selecting the first multi-link network device to transmit the data unit information, within the temporary transmission time, comprises:
in a case where it is determined that the second multi-link network device receives a first synchronization signal transmitted by the first multi-link network device, acquiring a first temporary transmission time received by the second multi-link network device when receiving the first synchronization signal, and selecting the first multi-link network device to transmit the data unit information within the first temporary transmission time;
in a case where it is determined that the second multi-link network device receives a second synchronization signal transmitted by the first multi-link network device after the first multi-link network device transmits the data unit information within the first temporary transmission time, recovering, according to the second synchronization signal, transmission of the data unit information by the second multi-link network device; and
in a case where it is determined that the second multi-link network device does not receive the second synchronization signal transmitted by the first multi-link network device after the first multi-link network device transmits the data unit information within the first temporary transmission time, autonomously recovering, transmission of the data unit information by the second multi-link network device.

5. The method for transmitting data unit information according to claim 3, wherein the selecting the second multi-link network device to transmit the data unit information, within the temporary transmission time, comprises:
in a case where it is determined that the first multi-link network device receives a third synchronization signal transmitted by the second multi-link network device, acquiring a second temporary transmission time received by the first multi-link network device when receiving the third synchronization signal, and selecting the second multi-link network device to transmit the data unit information within the second temporary transmission time;
in a case where it is determined that the first multi-link network device receives a fourth synchronization signal transmitted by the second multi-link network device after the second multi-link network device transmits the data unit information within the second temporary transmission time, recovering, according to the fourth synchronization signal, transmission of the data unit information by the first multi-link network device; and
in a case where it is determined that the first multi-link network device does not receive the fourth synchronization signal transmitted by the second multi-link network device after the second multi-link network device transmits the data unit information within the second temporary transmission time, autonomously recovering, transmission of the data unit information by the first multi-link network device.

6. The method for transmitting data unit information according to claim 2, wherein the performing information synchronization with the second multi-link network device comprises:
in a case where it is determined that a link state of the at least one first link changes, performing, by the first multi-link network device, information synchronization with the second multi-link network device; or
in a case where at least one of the first configuration information or the second configuration information changes, performing, by the first multi-link network device, information synchronization with the second multi-link network device.

7. The method for transmitting data unit information according to claim 1, wherein the configuration information comprise at least one of target beacon transmission time information or delivery traffic indication map information of network links comprised in the at least one first link.

8. The method for transmitting data unit information according to claim 6, wherein the configuration information comprise a target wake time on network links comprised in the at least one first link, and the target wake time comprises at least one of restricted target wake time, broadcast target wake time, or individual target wake time.

9. The method for transmitting data unit information according to claim 8, wherein it is determined that at least one of the first configuration information or the second configuration information changes by following operations:
in a case where it is determined that target beacon transmission time information of the first network link changes, determining that the first configuration information between the target multi-link device and the first multi-link network device changes, or
in a case where it is determined that target beacon transmission time information of a second network link changes, determining that the second configuration information between the target multi-link device and the second multi-link network device changes.

10. The method for transmitting data unit information according to claim 8, wherein it is determined that at least one of the first configuration information or the second configuration information changes by following operations:
in a case where it is determined that the target wake time of the network links comprised in the at least one first link changes, determining that at least one of the first configuration information or the second configuration information changes;
wherein the network links comprised in the at least one first link comprise at least one of the first network link and the second network link.

11. The method for transmitting data unit information according to claim 10, wherein it is determined that the target wake time on the network links comprised in the at least one first link changes by one of following operations:
in a case where it is determined that the target multi-link device joins or exits at least one of a restricted target wake time group or a broadcast target wake time group of the first multi-link network device on the first network link, when it is detected that at least one of the restricted target wake time or the broadcast target wake time of the first network link changes, determining that the target wake time of the network links comprised in the at least one first link changes;
in a case where it is determined that the target multi-link device creates or deletes at least one of a restricted target wake time group or a broadcast target wake time group of the second network link on the second network link, determining that the target wake time of the network links comprised in the at least one first link changes; or
in a case where it is determined that an individual target wake time group of the network links comprised in the at least one first link is created or adjusted, when it is detected that the individual target wake time of the network links comprised in the at least one first link changes, determining that the target wake time of the network links comprised in the at least one first link changes.

12. The method for transmitting data unit information according to claim 6, wherein it is determined that the link state of the at least one first link changes by one of following operations:
for any network link comprised in the at least one first link, determining that the link state of the at least one first link changes in a case where it is determined that any one of following conditions is met: the network link is deleted, the network link is a link newly added, the network link enters a sleep state, or the network link is disabled; and
for the at least one first link, in a case where it is determined that a base station end of the target multi-link device of the at least one first link enters a sleep state, determining that the link state of the at least one first link changes.

13. The method for transmitting data unit information according to claim 1, wherein the performing information synchronization with the second multi-link network device comprises at least one of:
transmitting, by the first multi-link network device, a fifth synchronization signal to the second multi-link network device, and in a case where it is determined that the first multi-link network device receives a response signal transmitted by the second multi-link network device based on the fifth synchronization signal, determining that the information synchronization is successful, wherein the fifth synchronization signal is a bidirectional signal;
successful transmitting, by the first multi-link network device, a sixth synchronization signal to the second multi-link network device, then determining that the information synchronization is successful, wherein the sixth synchronization signal is a unidirectional signal.

14. The method for transmitting data unit information according to claim 1, wherein the method further comprises:
in a case where it is determined that the second multi-link network device receives a seventh synchronization signal transmitted by the first multi-link network device, acquiring a third temporary transmission time received by the second multi-link network device when receiving the seventh synchronization signal;
starting timing from a reception time of the seventh synchronization signal to obtain a first timing time; and
in a case where it is determined that a difference between the first timing duration and the third temporary transmission time is less than a preset threshold, and the second multi-link network device does not receive an eighth synchronization signal transmitted by the first multi-link network device, transmitting, by the second multi-link network device, an unlocking signal to the second multi-link network device, so that the second multi-link network device recovers transmission of the data unit information based on the unlocking signal.

15. The method for transmitting data unit information according to claim 1, wherein the method further comprises:
in a case where it is determined that the second multi-link network device receives a ninth synchronization signal transmitted by the first multi-link network device, acquiring a fourth temporary transmission time received by the second multi-link network device when receiving the ninth synchronization signal;
starting timing from a reception time of the ninth synchronization signal to obtain a second timing time; and
keeping the second multi-link network device turned off in a case where any of following conditions is met:
it is determined that a difference between the second timing duration and the fourth temporary transmission time is less than a preset threshold; or
it is determined that the difference between the second timing duration and the fourth temporary transmission time is greater than the preset threshold, and the second multi-link network device does not receive a tenth synchronization signal transmitted by the first multi-link network device.

16. The method for transmitting data unit information according to claim 1, wherein network links comprised in the at least one first link belong to a same multi-link network device, or the network links comprised in the at least one first link belong to different multi-link network devices.

17. The method for transmitting data unit information according to claim 1, wherein the method further comprises:
transmitting, by a multi-link network device on any network link, at least one eleventh synchronization signal to the target multi-link devices of the plurality of non-asynchronous multi-links, wherein the at least one eleventh synchronization signal comprises at least one synchronization signal directed to the target multi-link devices of the plurality of non-asynchronous multi-links.

18. The method for transmitting data unit information according to claim 2, wherein the configuration information comprise at least one of target beacon transmission time information or delivery traffic indication map information of network links comprised in the at least one first link.

19. A non-transitory computer-readable storage medium, storing a computer program therein, wherein the computer program is configured to, when executed by a processor, cause the processor to:
establish at least one first network link with a target multi-link device, and perform information synchronization with a second multi-link network device; wherein at least one second network link is established between the target multi-link device and the second multi-link network device; and
transmit, through at least one of the first multi-link network device or the second multi-link network device, the data unit information within a configured transmission time corresponding to a configuration information.

20. An electronic device, comprising a memory and a processor, wherein the memory stores a computer program, and the processor is configured to execute the computer program to:
establish at least one first network link with a target multi-link device, and perform information synchronization with a second multi-link network device; wherein at least one second network link is established between the target multi-link device and the second multi-link network device; and
transmit, through at least one of the first multi-link network device or the second multi-link network device, the data unit information within a configured transmission time corresponding to a configuration information.
